(19) United States
(12) Patent Application Publication
(10) Pub. No.: US 2006/0004957 A1
(43) Pub. Date: Jan. 5, 2006

(54) Storage system architectures and multiple caching arrangements

(76) Inventors: Leroy C. Hand III, Vienna, VA (US); Arnold A. Anderson, Raleigh, NC (US); Amy D. Anderson, Raleigh, NC (US); Linda G. McClure, Vienna, VA (US)

Correspondence Address: DLA PIPER RUDNICK GRAY CARY US LLP, P. O. BOX 9271, RESTON, VA, 20195, US

(21) Appl. No.: 11/080,846

(22) Filed: Mar. 16, 2005

Related U.S. Application Data
(63) Continuation-in-part of application No. PCT/US03/28758, filed on Sep. 16, 2003.
(60) Provisional application No. 60/410,797, filed on Sep. 16, 2002.
(60) Provisional application No. 60/410,795, filed on Sep. 16, 2002.

(51) Int. Cl. G06F 12/00

(52) U.S. Cl. 711/113; 711/114

(57) ABSTRACT

An arrangement is provided for storage systems that use solid state disks for multiple functions. Solid state disks can be configured as cache under the control of a RAID controller. In some embodiments, a storage space can be divided into multiple zones according to information access traffic patterns.

### CROSS-REFERENCE TO RELATED APPLICATIONS

This application is a continuation of International Application No. PCT/US03/28758, filed on Sep. 16, 2003, which, in turn, is based on and derives the benefit of U.S. Provisional Patent Application 60/410,797, filed on Sep. 16, 2002, and 60/410,795, filed on Sep. 16, 2002, the entire contents of each of which are incorporated herein by reference.

### FIELD OF INVENTION

The present invention relates to storage system architecture and arrangements for caching information to and from the storage systems.

### BRIEF DESCRIPTION OF THE DRAWINGS

Exemplary embodiments of this invention are described in detail with reference to the drawings. In the drawings, like reference numerals represent similar parts throughout the several views, and wherein:

FIG. 1 depicts the architecture of a storage component, in which a cache is placed below a redundant array of inexpensive disks (RAID) controller, according to an embodiment of the present invention;

FIG. 2 is a flowchart of an exemplary process, in which a storage component facilitates information storage;

FIG. 3 depicts the architecture of a different storage component, which utilizes solid state disks for storage, according to an embodiment of the present invention;

FIG. 4 depicts the architecture of yet another storage component employing solid state disks as cache for rotating storage below a RAID controller, according to an embodiment of the present invention;

FIG. 5 is a flowchart of an exemplary process, in which a storage component performs information exchange, according to an embodiment of the present invention;

FIG. 6 depicts the architecture of an exemplary storage system, in which a storage management system manages the storage space comprising a combination of solid state disks, rotating disks, and cache for the rotating disks, according to an embodiment of the present invention;

FIG. 7 depicts the architecture of a configurable storage system, with configurable storage components comprising solid state disks, caches, and rotating disks, according to an embodiment of the present invention;

FIG. 8(a) is a flowchart of an exemplary process, in which a configurable storage system processes an information access request, according to an embodiment of the present invention;

FIG. 8(b) shows a functional view of a configurable storage system with respect to multiple caching, in which storage space is divided into a plurality of caching zones that are managed based on dynamic traffic patterns, according to an embodiment of the present invention;

FIG. 8(c) is a flowchart of an exemplary process, in which a configurable storage system manages storage using a multiple caching scheme, according to an embodiment of the present invention;

FIG. 9 depicts how a multiple caching mechanism interacts with three different caching zones to achieve dynamic multiple caching, according to an embodiment of the present invention;

FIG. 10 illustrates an exemplary information access acknowledgement scheme, according to an embodiment of the present invention;

FIG. 11 depicts an exemplary internal structure of a multiple caching mechanism, according to an embodiment of the present invention;

FIG. 12(a) is a flowchart of an exemplary process, in which a multiple caching mechanism realizes a multiple caching scheme based on traffic dynamics, according to an embodiment of the present invention;

FIG. 12(b) is a flowchart of an exemplary process, in which a multiple caching mechanism makes a data migration determination according to traffic pattern classification, according to an embodiment of the present invention;

FIG. 12(c) is a flowchart of an exemplary process, in which a multiple caching mechanism makes a data migration determination according to traffic pattern classification, according to a different embodiment of the present invention;

FIG. 12(d) is a flowchart of an exemplary process, in which a multiple caching mechanism makes a data migration determination according to traffic pattern classification, according to a different embodiment of the present invention;

FIG. 12(e) is a flowchart of an exemplary process, in which a storage management mechanism handles an access request, according to an embodiment of the present invention;

FIG. 13 depicts a distributed storage system, according to an embodiment of the present invention; and

FIG. 14 depicts a framework in which a configurable storage system serves the storage needs of a plurality of hosts.

### DETAILED DESCRIPTION OF EXEMPLARY EMBODIMENTS

The processing described below may be performed by a properly programmed general-purpose computer alone or in connection with a special purpose computer. Such processing may be performed by a single platform or by a distributed processing platform. In addition, such processing and functionality can be implemented in the form of special purpose hardware or in the form of software or firmware being run by a general-purpose or network processor. Information handled in such processing or created as a result of such processing can be stored in any memory as is conventional in the art. By way of example, such information may be stored in a temporary memory, such as in the RAM of a given computer system or subsystem. In addition, or in the alternative, such information may be stored in longer-term storage devices, for example, magnetic disks, re-write able optical disks, and so on. For purposes of the disclosure herein, a computer-readable media may comprise any form of information storage mechanism, including such existing memory technologies as well as hardware or circuit representations of such structures and of such information.

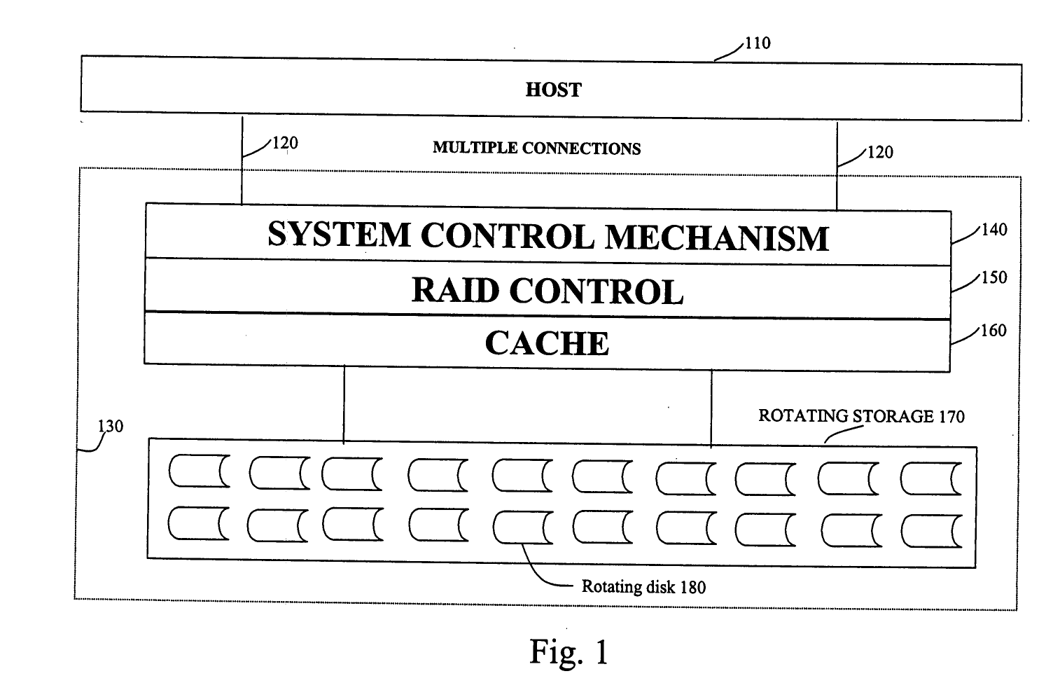

FIG. 1 depicts the architecture of a storage component 130, in which a cache 160 is placed between a redundant array of inexpensive disks (RAID) controller 150 and a rotating storage 170, according to an embodiment of the present invention. The storage component 130 includes a system control mechanism 140, the RAID controller 150, the cache 160, and the rotating storage 170 comprising a plurality of rotating disks. The cache 160 may reside on the RAID controller card and serves as cache storage for the rotating storage 170.

The system control mechanism 140 interfaces with host 110 via one or more connections 120 between the storage component 130 and the host 110. The host 110 is generic and it may represent a server, a host, or an application server. The host 110 may also correspond to a plurality of hosts that are connected to the storage component 130 via one or more connections. The system control mechanism 140 receives information access requests from the host 110 and controls the information movement. For example, it may translate an information access request into information movement instructions and send such instructions to the RAID controller 150 to execute the information access instructions.

The cache 160 provides cache for the rotating disks. The cache 160 is configurable or programmable to serve as one of the three types of cache: read cache, write cache, or multiple cache meaning both read and write cache. When the cache 160 is programmed as a read cache, any read operation is through the cache 160. When the cache 160 is programmed as a write cache, any write operation is through the cache 160. When the cache 160 is programmed for both read and write caching, any information transfer is through the cache 160.

An information movement instruction is sent to the cache 160 only when the requested information access operation is related to the designation of the cache 160. For example, if the cache 160 is designated as a write cache, only information movement instructions related to writing information is sent to the cache 160. In this case, all read related information movement instructions will be sent to the rotating storage 170 directly.

Upon receiving a information movement instruction, the cache 160 performs the corresponding information movement operation. For instance, when information access is related to reading information, the cache 160 may check whether the requested information is already stored in the cache. If the information is already in the cache, the cache 160 may retrieve the requested information and return the information to the system control mechanism 140. If the requested information is not in the cache, the cache 160 fetches the information from the rotating storage 170, stores the information in the cache, and returns the information to the system control mechanism 140. When the requested information movement operation is completed within the cache 160, the cache 160 sends an acknowledgement back to the system control mechanism 140. When the system control mechanism 140 receives the acknowledgement, it may transmit a signal to the host 110 to indicate that the requested operation has been completed. In the case of reading information, the system control mechanism 140 may also pass the information read to the host 110.

When the cache 160 serves as a write cache of the rotating storage 170, the cache 160 sends an acknowledgement back to the system control mechanism 140 before it completes writing the information into the rotating storage 170. In fact, such acknowledgement can be sent before information is written into the rotating storage 170. That is, the cache 160 sends the acknowledgement back to the system control mechanism 140 right after the information is written to the cache and before the write to the rotating storage is completed. Since a cache write is usually much faster than a disk write, sending out the acknowledgement before completing the disk write reduces the latency. When the cache 160 is full, it may not send the acknowledgment until the write to the disk is completed. That is, if there is space in the cache 160, the write latency is effectively reduced.

In FIG. 1, only one RAID controller is shown. The storage component 130 may also have more than one RAID controller. For instance, dual RAID controllers may be provided in a same storage component. Different RAID controllers may cover different portions of the underlying storage space or may also cover the entire storage space. When one of the RAID controller fails, the other, with a full coverage of the entire storage space, may take over the operation so that fault tolerance can be achieved.

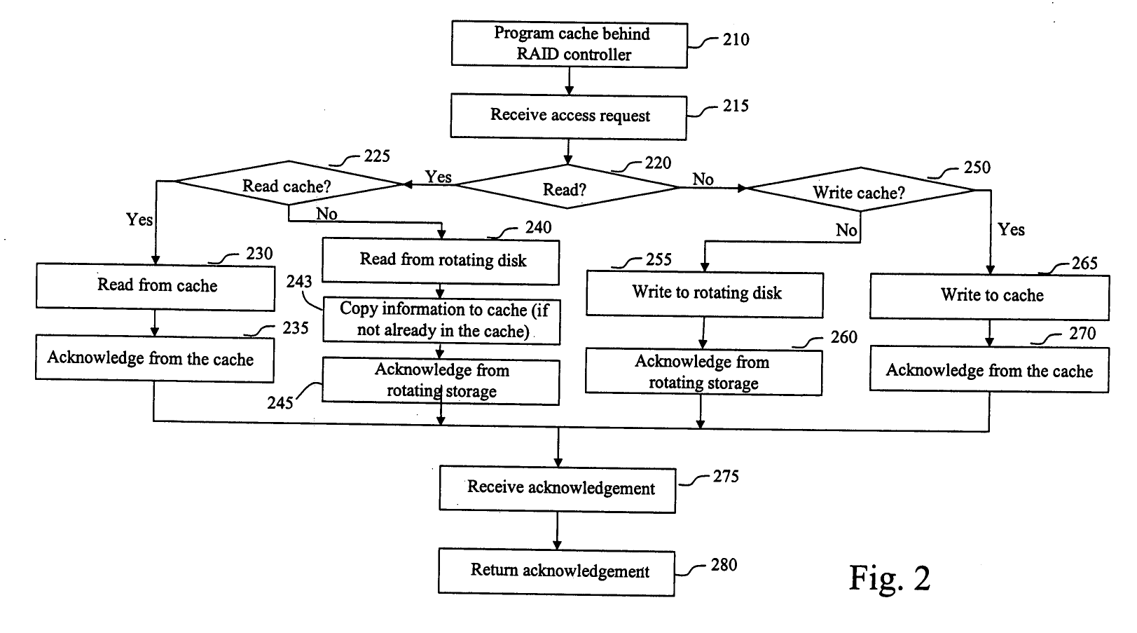

FIG. 2 is a flowchart of an exemplary process, in which the storage component 130 interacts with the host 110 to facilitate data storage. The cache 160 behind the RAID controller 150 is first programmed at act 210 as a write cache, read cache, or multiple cache. The designation of the cache 160 is indicated to the system control mechanism 140 and the RAID controller 150. Upon receiving, at act 215, an information access request from the host 110, the system control mechanism 140 determines, at act 220, whether the information access request is a read or a write operation. If it is a read operation, the cache 160 is designated as either for read caching or for multiple caching (read and write), and the information is in the cache 160 (determined at act 225), the system control mechanism 140 sends read instructions to the cache 160. The cache 160 subsequently reads, at act 230, the information requested and acknowledges, at act 235, when the cache read is completed. If the information access request relates to a read but the cache 160 is not designated as a read cache, the information is read, at act 240, from the rotating storage. If the information access request relates to a read, cache 160 is configured as a read cache, but if the requested information is not in the cache 160, the information is read, at act 240, from the rotating storage 170 and the information read is copied, at act 243, to the cache 160. When the rotating storage completes the read operation, it sends an acknowledgement, at act 245, to the system control mechanism 140.

If the information movement instruction is a write operation and the cache 160 is designated as a write cache or a multiple cache, determined at act 250, the cache 160 performs the write operation at act 265 and, upon the completion of the write operation, the cache 160 acknowledges, at act 270, the write operation to the system control mechanism 140. The cache 160 then writes the information to the rotating storage 170. If the cache 160 is not programmed as a write cache or cache 160 is full, the information movement instruction is sent to the rotating storage 170. The rotating storage then writes information to a rotating disk at act 255. Upon the completion of the write to the rotating disk, the rotating storage 170 acknowledges, at act 260, to the system control mechanism 140.

The system control mechanism 140 receives, at act 275, the acknowledgement (from either the cache 160 or the rotating storage 170), it returns an acknowledgement, at act 280, to the host 110 to indicate that the requested information movement has been completed.

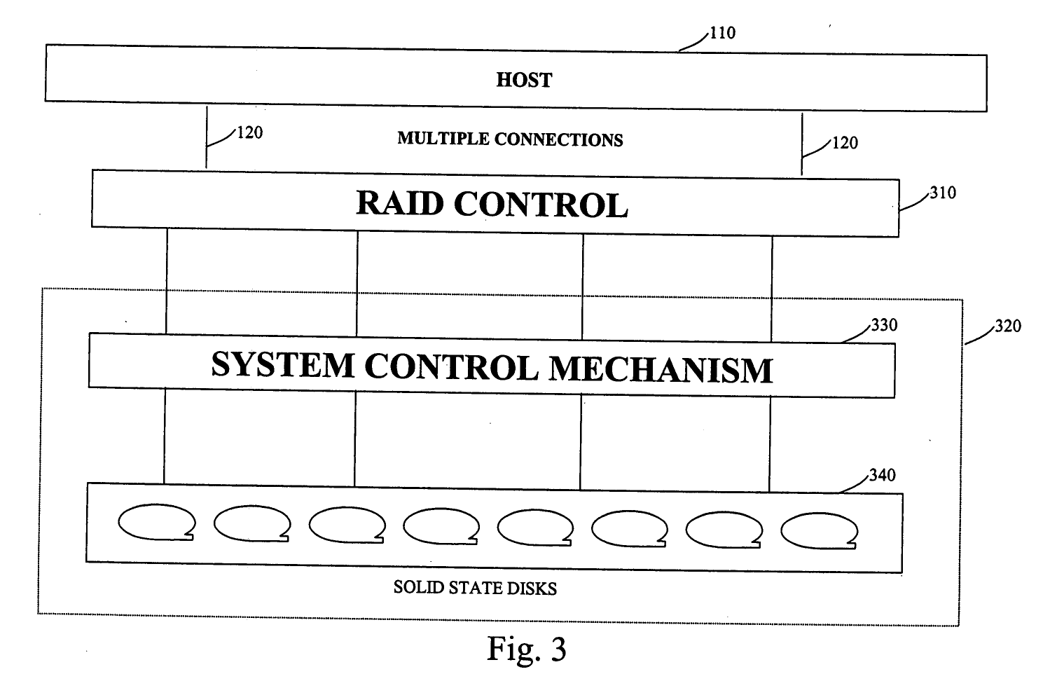

FIG. 3 depicts the architecture of a different storage component 320, which utilizes solid state disks for storage, according to an embodiment of the present invention. The storage component 320 comprises a system control mechanism 330 and a plurality of solid state disks 340. The system control mechanism 330 controls the information movement to and from the solid state disks 340. The storage component 320 interacts with an external RAID controller 310 that is connected to the host 110. Both the system control mechanism 330 and the solid state disks 340 are behind the RAID controller 310.

According to some embodiments of the present invention, each of the solid state disks in the storage component 320 is individually configurable. For example, a solid state disk can be programmed to serve as a cache or as an independent storage device. As a cache, a solid state disk can be configured as a read cache, a write cache, or a read and write cache. In this case, a solid state disk may provide external cache for the host 110.

If a solid state disk is programmed as an independent storage device, it may be programmed simply as a generic storage space or as a special storage space that locks frequently accessed files for fast file access. In the latter case, the storage component 320 serves as a file cache. The files stored in such configured solid state disks may be fixed or locked for a certain period of time. The locked files may be determined based on various criteria. For instance, the host may decide to cache a plurality of files that are used at high frequency by different applications. By storing such files in a fast access medium, the overall performance is improved. Such locked files may be changed when needed.

The solid state disks 340 may be configured individually prior to deploying the storage component 320. Different solid state disks in the storage component 320 may be configured differently. For example, some may be configured as read, some as write, and some as lock. They can also be configured uniformly. For instance, for file cache purposes, all the solid state disks within one storage component may be configured to lock files. In addition, solid state disks 340 may also be reconfigured during operation whenever such need arises.

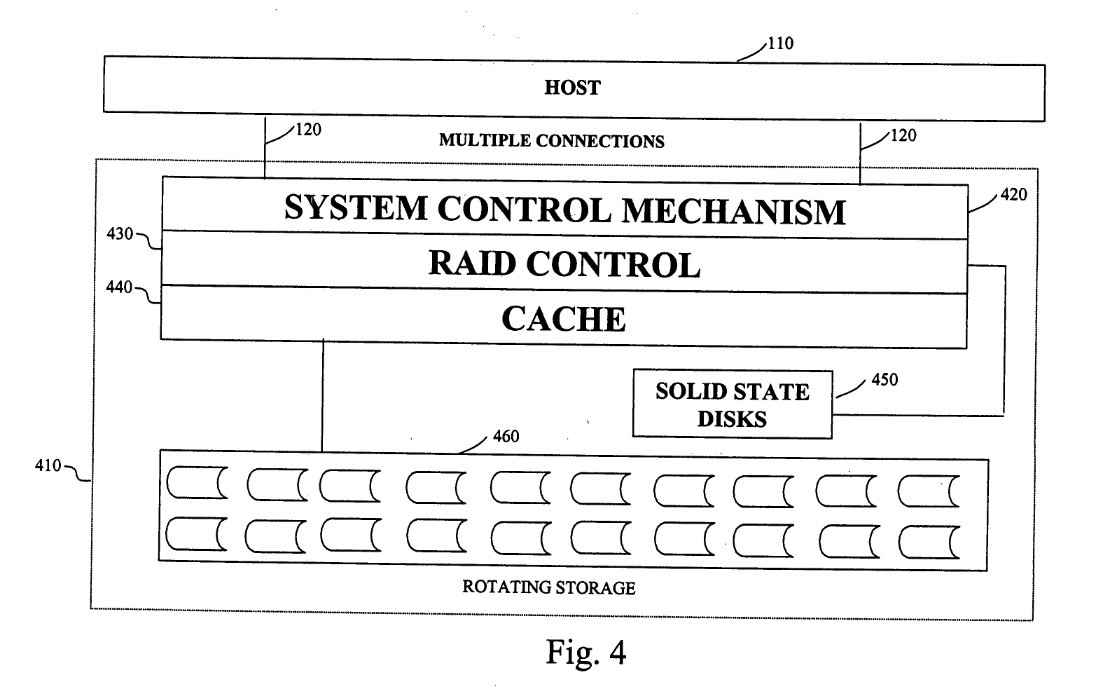

FIG. 4 depicts the architecture of yet another storage component 410 that employs solid state disks as cache between a rotating storage and a RAID controller, according to an embodiment of the present invention. The storage component 410 comprises a system control mechanism 420, a RAID controller 430, a cache 440, one or more solid state disks 450, and a rotating storage 460 having at least one rotating disk. The system control mechanism 420 interacts with the host 110 via one or more connections 120 to perform information exchange. The cache 440 serves as a cache storage for the rotating storage 460 and can be programmed for different purposes (read, write, read/write) as described earlier.

The solid state disk 450 is accessed through the RAID controller 430 and can be configured to serve different purposes. The solid state disk 450 may be programmed to provide additional cache for the rotating storage 460. For example, the solid state disk 450 may be used as a secondary cache. That is, when the cache 440 is full, the solid state disk 450 is used as an extension of the cache 440 for caching purposes. In this case, the cache 440 is the primary cache. However, the solid state disk 450 may also be programmed as the primary cache. In this case, the cache 440 may be used as a secondary cache when the solid state disk 450 is full. Furthermore, the solid state disk 450 may also be programmed to provide independent storage space (instead of cache). Such independent storage space may be used to store data or files.

As described earlier, multiple solid state disks may be configured individually. With this flexibility, it is possible that different solid state disks are programmed for different purposes. For example, some of the solid state disks may be programmed as cache and some as storage space. Different parts of the solid state disks that are configured as cache may be designated for different functions such as read, write, or read/write cache. Similarly, the solid state disks that are configured as storage space may be programmed to store data or to lock files.

Once the solid state disks are programmed, such information is sent to the RAID controller 430. With such designation information, the RAID controller 430 directs information access requests to appropriate parts of the storage. For example, if the solid state disks 450 are programmed to lock certain files, names of such locked files may be sent to the RAID controller 430. When an information access request involves accessing one of those files, the RAID controller 430 directs the information request to the solid state disks 450. Similar to the discussion above, there may be more than one RAID controller in one storage component. Each of the RAID controllers may cover partial or full range of the storage space. When both controllers cover the full range of storage space, one can take over the entire operation when the other fails.

When a solid state disk is programmed as a write cache, after an information write request is processed, the solid state disk sends an acknowledgement to the system control mechanism 420 once the write operation to the solid state disk is completed and also writes the information to the rotating storage 460. That is, the solid state disk sends the acknowledgement before it completes the write to the rotating storage. Since solid state disks are faster than a rotating disk, this may significantly reduce the write latency.

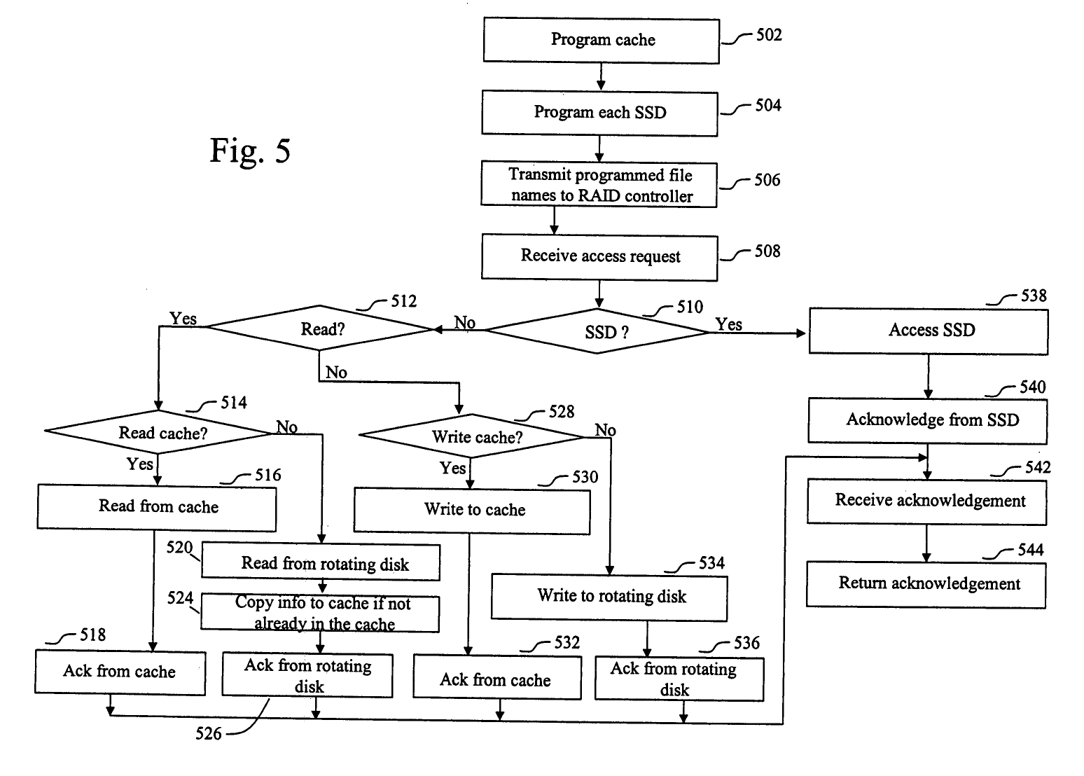

FIG. 5 is a flowchart of an exemplary process, in which the storage component 410 interacts with the host 110 to perform information exchange, according to an embodiment of the present invention. The cache 440 is first programmed at act 502. Then the solid state disks are individually programmed at act 504. The designations of the solid state disks (programmed functions) are transmitted, at act 506, from the solid state disks to the RAID controller 430. For instance, when a solid state disk is programmed to store locked files, the names of the locked files are sent to the RAID controller 430.

When the system control mechanism 420 receives, at act 508, an information access request, it is determined, at act 510, whether the requested information is or should be stored in one of the solid state disks. The requested information may be a piece of data or a file. If the requested information is not or should not be in one of the solid state disks, the information is or should be stored in either the cache 440 or the rotating storage 460. If the information is to be read (i.e., the requested information access is a read operation) and the information already resides in cache programmed as a read cache, determined at acts 512 and 514, the information is then read, at act 516, from the cache. When the cache 440 completes the read, it sends, at act 518, an acknowledgement to the system control mechanism 420.

If the requested operation is a read operation but the information is not in the cache (either the cache 440 is not designated as a read cache or the information is currently not in the cache 440 that is programmed as a read cache), the information is read, at act 520, from the rotating storage 460. If the cache 440 is designated as a read cache, the information that is just read from the rotating storage 460 is copied into the cache 440 for future access. The rotating storage 460 sends, at act 526, an acknowledgement to the system control mechanism 420 to signify the completion of the read.

If the requested operation is a write, it is determined, at act 528, whether the cache 450 is programmed to be a write cache. If the cache 450 is a write cache, the write operation is performed, at act 530, in the cache 450. Upon the completion of the cache write, the cache 440 sends, at act 532, an acknowledgement to the system control mechanism 420. Information from the cache 440 is written to the rotating storage 460. If the cache 450 is not a write cache or cache 450 is full, the write operation is carried out, at act 534, in the rotating storage 460. When rotating storage 460 completes the write operation, it sends, at act 536, an acknowledgement to the system control mechanism 420.

The requested information may also reside or should be stored in one of the solid state disks. This could be true in one of the following scenarios. First, the SSD 450 may serve as a cache for the rotating storage 460, either as primary or secondary. Second, the SSD 450 may serve as an independent storage, either for data storage or for locking files. When the requested information is already or should be stored in SSD, the SSD 450 is accessed at act 538. This may involve either a read operation or a write operation. Upon the completion of the operation, the SSD 450 sends, at act 540, an acknowledgement to the system control mechanism 420.

When both the cache 440 and the SSD 450 are programmed as cache, the secondary cache serves as a overflow cache. That is, the secondary cache is used only when the primary cache is full. For instance, if the cache 440 is the primary cache and the SSD 450 is the secondary cache, the SSD 450 is used as a cache only when the cache 440 is full. Therefore, the cache involved in copying and writing information performed at acts 524 and 530 may refer to either the primary or the secondary cache, depending on the dynamic situation.

Depending on the dynamic situation, an acknowledgement received by the system control mechanism 420 may be from one of the three possible sources, including the SSD 450, the cache 440, and the rotating storage 460. Since the SSD 450 may operate at the fastest speed, it may correspond to the shortest latency. The cache 440 usually operates at a speed lower than the SSD 450 but faster than the rotating storage 460. Therefore, it yields a latency longer than the SSD 450 and shorter than the rotating storage 460. This may be particularly so when a write operation is involved because a write to a rotating disk takes a longer time than a read from a rotating disk. The system control mechanism 420 intercepts acknowledgement from any of those three possible sources. Once the system control mechanism 420 receives the acknowledgement, at act 542, it forwards (or returns) the acknowledgement to the host 110 to indicate that the requested operation is completed. In the case of read operation, the information may also be sent with the acknowledgement.

Given the flexibility of programming individual parts separately (the cache 440 and each of the solid state disks), the storage component 410 may be configured based on needs. For instance, if speed is a high priority, the SSD 450 may be configured as a primary cache and the cache 440 may be configured as a secondary cache. A different alternative may be to configure the cache 440 as a read cache and the SSD 450 as a write cache due to the fact that a write operation is slower than a read operation. Yet another different alternative may be to configure the SSD 450 as an independent storage programmed to store information that is known to be accessed frequently.

When a write operation is performed in either the cache 440 or the SSD 450, an additional write operation to the rotating storage 460 may be subsequently performed (not shown in FIG. 5) after the acknowledgement is sent to the system control mechanism 420. This additional write operation takes much longer to complete. Yet, since the system control mechanism 420 does not need to wait for the completion of the slower write, the slower speed of writing to the rotating storage does not degrade the write latency.

The three storage components described so far (storage component 130, 320, and 410) may be used as plug-ins in any storage system. The system control mechanisms (i.e., 140, 330, and 420) in these storage components have standard interfaces so that they are interoperable with other storage systems, servers, or hosts. While they can be used individually, the described storage components may also be integrated to form configurable storage systems that may be further managed using specially designed storage management capabilities to further utilize the flexibility and capacity that the described storage components possess.

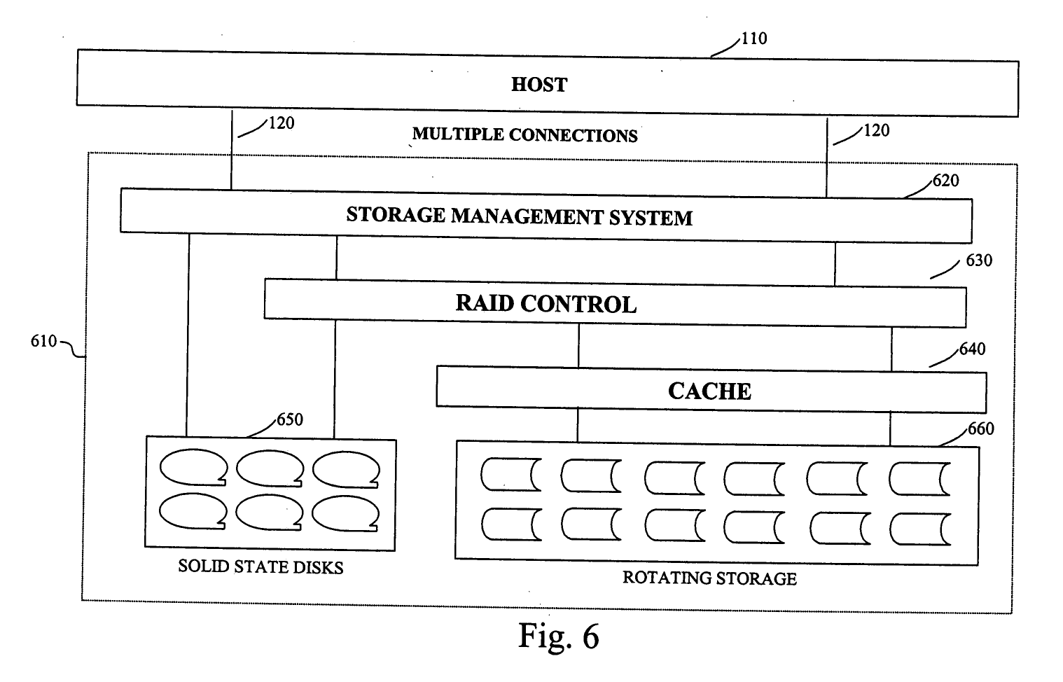

FIG. 6 depicts the architecture of an exemplary storage system 610, in which a storage management system manages the storage space comprising a combination of solid state disks, rotating disks, and cache of the rotating disks, according to an embodiment of the present invention. The storage system 610 comprises, but is not limited to, a storage management system 620, one or more RAID controller 630 (only one is shown), a cache 640, a plurality of solid state disks 650, and a rotating storage 660. Similar to what is described earlier, the storage system 610 interacts with the host 110 via one or more connections 120.

In the storage system 610, the storage management system 620 represents a generic storage management mechanism, capable of managing storage space and interfaces with the outside to process various information access requests. The storage management system 620 may be a conventional storage management system, which corresponds to a storage management software installed and running on a computer. Such a computer can be either a special purpose computer or a general purpose computer such as a server.

The storage management system 620 may reside at the same physical location as other parts such as the RAID controller 630, the cache 640, the solid state disks 650, and the rotating storage 660. The storage management system 620 may also be included with the other components in the enclosure.

The storage management system 620 manages the storage space either through the RAID controller 630 or directly. For example, as shown in FIG. 6, the solid state disks 650 may be controlled by either the RAID controller 630 or by the storage management system 620.

As described earlier, different storage components can be flexibly configured for different purposes. Therefore, the storage system 610 that is formed using such storage components also presents a high degree of flexibility. For example, individual solid state disks may be configured differently. In addition, the storage system 620 is scalable. When demand for storage increases, storage components such as 130, 320, and 410 may be added to the storage system 620 without changing the storage management mechanism 620. When a new storage component is added, the added component as well as individual solid state disks in the added component may be configured as needed. Furthermore, existing components as well as its internal solid state disks may also be re-configured when requirements change.

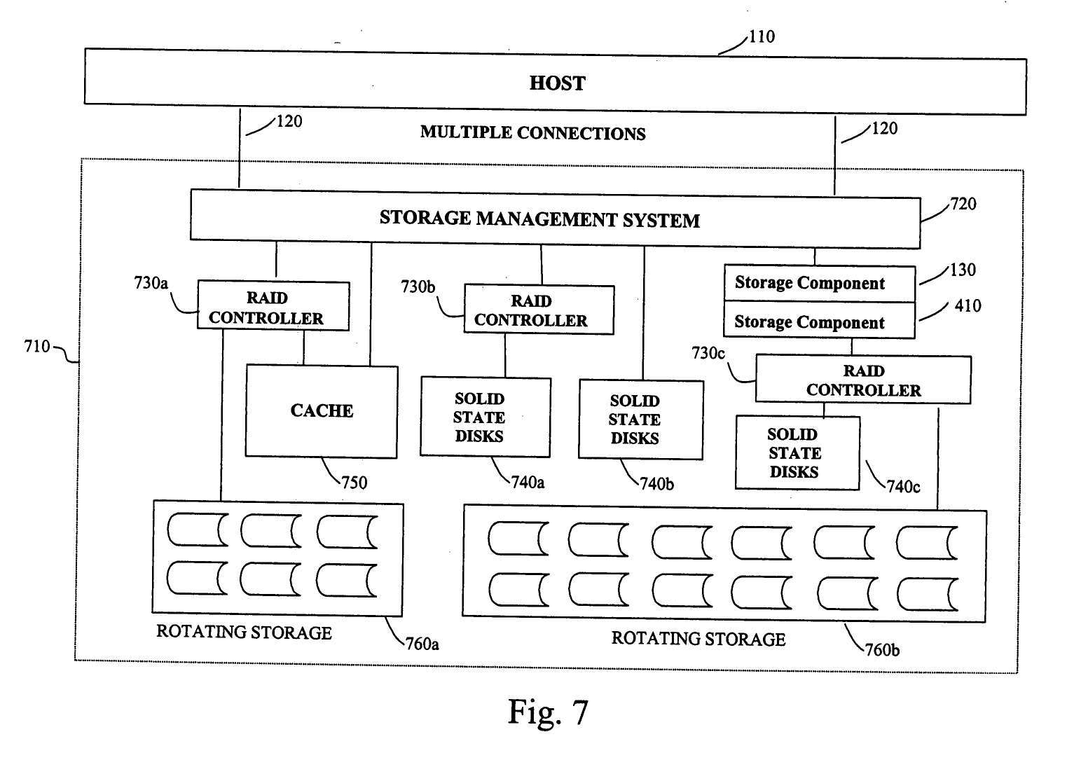

FIG. 7 depicts the architecture of a configurable storage system 710, with configurable storage components comprising solid state disks, caches, and rotating disks, according to an embodiment of the present invention. The configurable storage system 710 comprises, but is not limited to, a storage management system 720, a plurality of RAID controllers (e.g., 730a, 730b, and 730c), a plurality of groups of solid state disks (e.g., 740a, 740b, and 740c), a solid state disk(s) 750 used for caching purposes, one or more storage components (e.g., 130, 410) described earlier, and a plurality of rotating storages (e.g., 760a and 760b). The storage management system 720 manages the storage space (formed by the multiple solid state disks 740a, 740b, 740d, the storage components 130 and 410, file cache 750, and rotating storages 760a and 760b).

In the configurable storage system 710, some of the storage components may reside in the same enclosure as the storage management system 720 and some may reside outside of the enclosure. For example, the rotating storage 760a may be inside of the enclosure and the rotating storage 760b may reside outside of the enclosure. Storage components residing outside of the enclosure may link to the storage management system 720 via one or more connections.

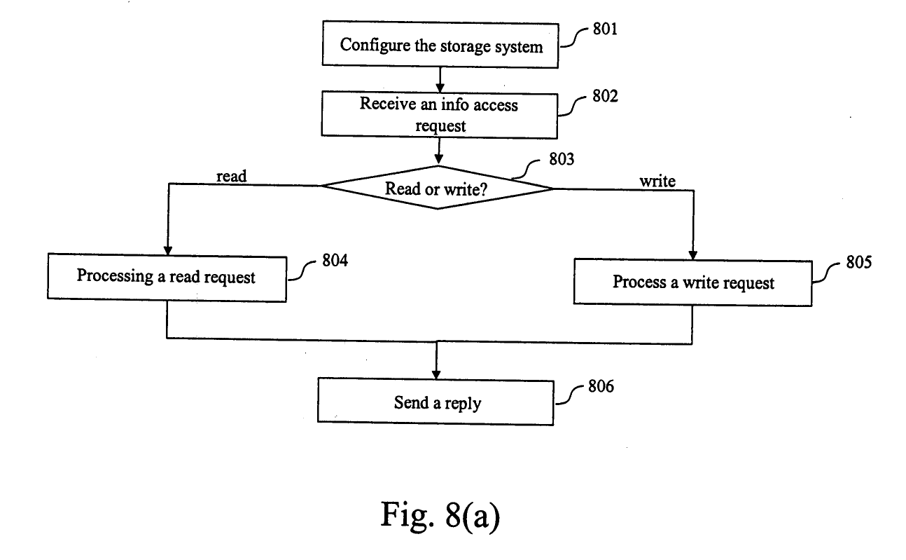

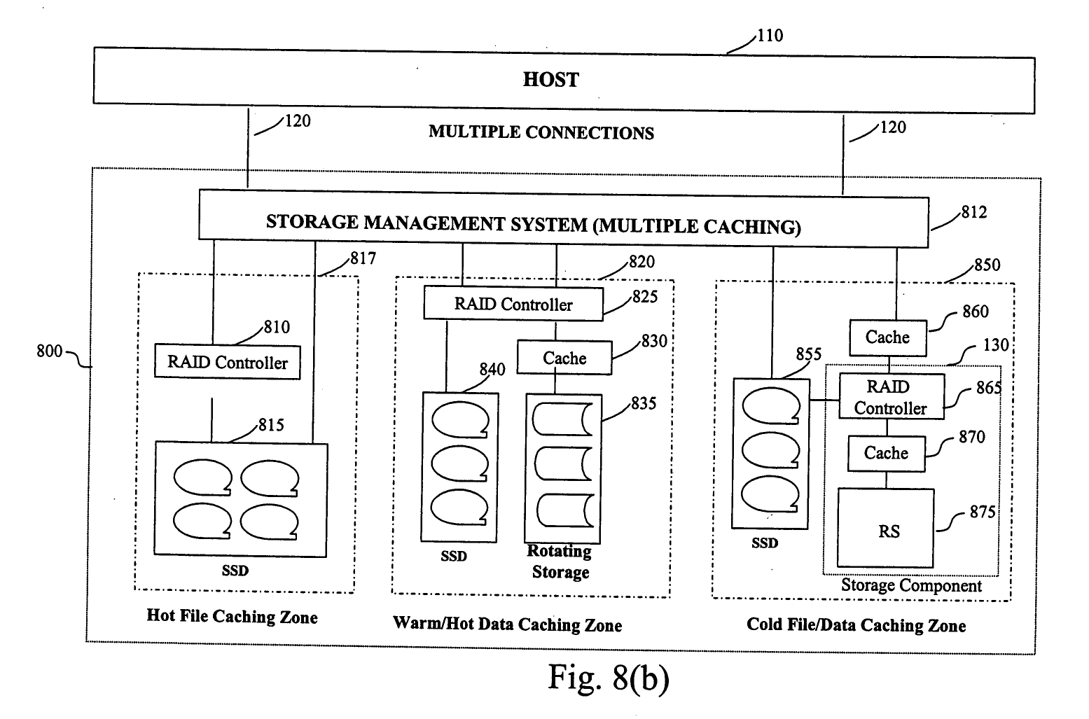

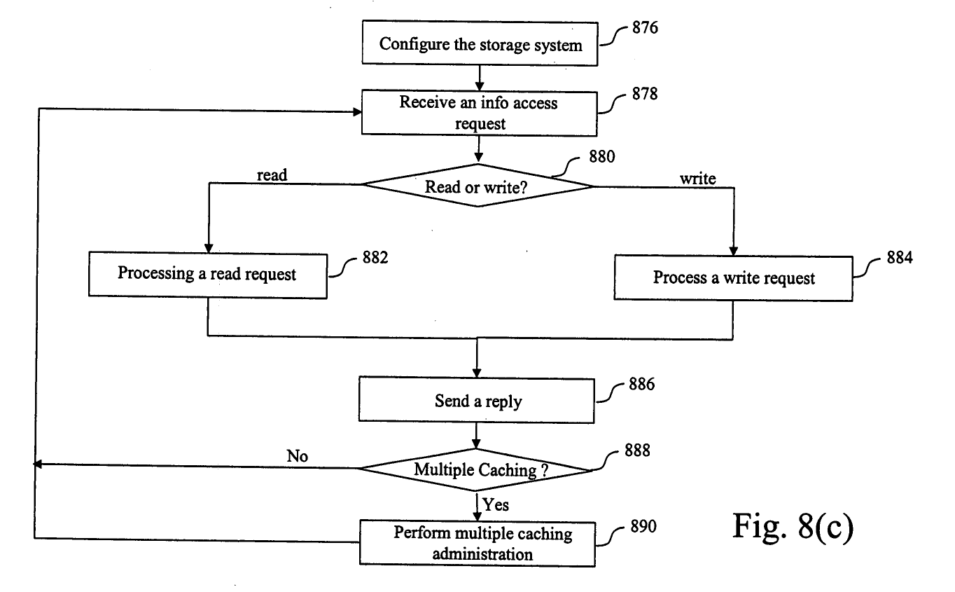

FIG. 8(a) is a flowchart of an exemplary process, in which the configurable storage system 710 processes an information access request, according to an embodiment of the present invention. The storage space is first configured at act 801. When the configurable storage system 720 receives, at act 802, an information access request from the host 110, it is determined, at act 803, whether the request is a read or a write request. A read request is processed at act 804. A write request is processed at act 805. After the information access request is processed, the configurable storage system 710 sends, at act 806, a reply to the host that issues the request.

Similar to the storage management system 620, the storage management system 720 may also be deployed on a computer that may correspond to a general server. Furthermore, such a deployed storage management system may possess additional functionalities. In some embodiments, a storage management system may be configured to divide a storage space into multiple zones and different storage zones may be designated to data with certain traffic patterns. FIG. 8(b) shows a functional view of a configurable storage system 800 in which a storage space is divided into a plurality of caching zones that are managed based on dynamic information traffic patterns, according to an embodiment of the present invention. In FIG. 8(b), the storage space is divided into three zones: a file caching zone 817, a warm/hot data caching zone 820, and a cold file/data caching zone 850. In the illustrated example, the three zones are used to store data or files that have different underlying information access patterns. For instance, data or files that are frequently accessed may be classified as hot. Data or files that are accessed infrequently may be classified as cold. Any data with an access pattern in between “frequent” and “infrequent” may be classified as warm. In the illustration, the hot file caching zone 817 stores hot files; the warm/hot data caching zone 820 stores warm or hot data (at least portions of files); and the cold file/data caching zone 850 stores cold files or data. A storage management system 812 with multiple caching capabilities manages the three zones according to dynamic information traffic patterns.

Each storage zone may be configured to include solid state disks to enhance performance. For instance, the hot file caching zone 817 may include a solid state disk(s) (SSD) 815 controlled by a RAID controller 810 to minimize the number of SSDs required to provide increased data integrity and availability. The warm/hot data caching zone 820 comprises one or more RAID controllers 825 (one is shown in FIG. 8(b)), which controls a cache 830, a rotating storage 835, and the solid state disk(s) 840. The cache 830 serves as a cache (read, write, or read/write) of the rotating storage 835, which stores warm data. The solid state disk(s) 840 stores hot data. The cold file/data caching zone 850 stores files and data that are cold. It includes a cache 860, a storage component 130, and a solid state disk(s) 855. As described earlier, the storage component 130 comprises a RAID controller 865, a cache 870, and a rotating storage 875. The solid state disks 855 are behind the RAID controller 865. If speed is critical and high data availability is not critical, then there may be a direct connection from the SSD 855 to the manager 812.

The storage in each zone may be configured according to the needs of the particular zone. For instance, since hot files/data are accessed more frequently, storing them in faster medium may enhance the overall performance. On the other hand, since cold files/data are not accessed often, storing them in a slower medium may not degrade the overall performance. Alternative criteria may also be used in determining the storage configuration of different zones.

To facilitate fast and frequent hot file access, the hot file caching zone may be configured to comprise only solid state disk(s) (e.g., 815), as shown in FIG. 8(b). Hot files may be identified by a database administrator (DBA) and the SSD 815 may be configured to store such identified hot files. Once the hot files are stored in the hot file zone 817, they may not be moved until the SSD 815 is reconfigured. Re-configuration may occur when either some of the files in the hot file caching zone 817 are no longer hot (i.e., they may be accessed much less frequent) or other files are identified as hot and need to be stored in the hot file caching zone 817. The storage management system 812 may monitor the dynamic traffic patterns of all the files stored in the configurable storage system 800 and report such monitored information. A DBA may utilize such monitored to determine whether files need to be migrated. For instance, hot files stored in the hot file caching zone 817 may be removed if they are no longer hot and files stored in the cold data/file caching zone 850 may be moved to the hot file caching zone 817 if they become hot.

The solid state disk(s) 815 in the hot file caching zone 817 may be placed behind one or more RAID controllers (e.g., the RAID controller 810). As described earlier, when the SSD 815 is configured for certain files, the names of such files are transmitted to the RAID controller 810 so that information access requests related to the hot files will be directed the SSD 815. The RAID controller 810 may reside at a same physical device as the SSD 815 or it may reside in a different physical device. For example, the RAID controller 810 may be installed in a same physical device as the storage management system 720.

The cold file/data caching zone 850 has two levels of cache (i.e., 860 and 870). One may be programmed as a read cache and the other may be programmed as a write cache. For instance, cache 860 may serve as a read cache and cache 870 may serve as a write cache. The solid state disk(s) 855 may be configured to serve different purposes, depending on the needs. For example, the solid state disk(s) 855 may be configured as a secondary write cache for the rotating storage 875. That is, when the cache 870 (which is a write cache for the rotating storage 875) is full, the write caching is extended to the SSD 855. Alternatively, the SSD 855 may be configured as a primary cache for the rotating storage 875 and the cache 870 as a secondary cache. In this case, the cache 870 takes over when the SSD 855 is full. Since write operations can be slower than read operations, a large write cache can improve performance. As yet another alternative, the SSD 855 may be configured as simply storage space.

The files/data stored in the cold file/data caching zone 850 may migrate to other zones when they become either warm or hot. When a file becomes hot, it may be moved to the hot file caching zone 817. When a hot file becomes cold again, it is moved back from the hot file caching zone 817 back to the cold file/data caching zone 850.

If a piece of cold data becomes warm or hot, it may be written to the warm/hot data caching zone 820. When a piece of data is written to a warmer zone, it is also retained in the cold data zone 850. When the data is updated (re-written), both copies get updated at the same time. In this fashion, when the data becomes cold again, there is no need to write the data from a warmer zone back to the cold zone. This enables one directional information movement.

To facilitate efficient access to data that is either warm or hot, the warm/hot data caching zone 820 has separate storage areas for warm and hot data. To enhance performance, the illustrated embodiment shown in FIG. 8(b) uses the solid state disk(s) 840 to store hot data and the rotating storage 835 to store warm data. The cache 830 may be programmed as a read/write cache for the rotating storage 835.

When a piece of cold data becomes warm, it is written from the cold file/data caching zone 850 to the rotating storage 835 (warm data zone). Compared with the rotating storage 875 in the cold file/data caching zone 850, the rotating storage 835 in the warm/hot data caching zone 820 is faster. This may be achieved by, for example, having the warm/hot data caching zone 820 residing on a same physical device as the storage management system 720. In addition, since the cold file/data caching zone 850 may store a majority of the data, it may have a much larger storage space which may even be located at one or more remote sites.

When a piece of warm data is updated (re-written), it is written first to the cache 830. The cache 830 acknowledges a write before the write to the rotating storage 835 is completed. As discussed above, another write operation is performed at the same time to update the copy of the same data stored in the cold file/data caching zone 850. Both the cache 830 and the write cache 870 may send a write acknowledgement to the storage management system 720 upon the completion of a cache write. The storage management system 720 may act upon the first received acknowledgement from the cache 830.

When a piece of cold data becomes hot, it is written from the cold file/data caching zone 850 to the solid state disks 840 (hot data zone) via the RAID controller 825. Similar to a piece of warm data, the original version of a piece of hot data is retained in the cold file/data caching zone 850. Whenever the data is updated, it is re-written to both the hot data zone (the solid state disks 840) and the cold file/data caching zone 850. Here, since the hot data is stored in a solid state disk, the acknowledgement from the hot data zone may be faster than that from the cold data zone.

Within the warm/hot data zone 820, data migration may occur when a piece of warm data becomes hot. In this case, the hot data is migrated from the rotating storage 835 to the solid state disk(s) 840 through the RAID controller 825. In this case, there may be two copies of the same data, one is stored in the solid state disk(s) 840 and the other is stored in the cold file/data caching zone 850. Future updates of the data will be directed to both the solid state disk(s) 840 and the cold file/data caching zone 850.

With the multiple caching schemes, the storage is functionally organized into a hierarchy, in which the hottest data/files are accessed at the fastest speed, warm data is in the middle, and the cold data/files are at the bottom of the hierarchy, accessed at the slowest speed.

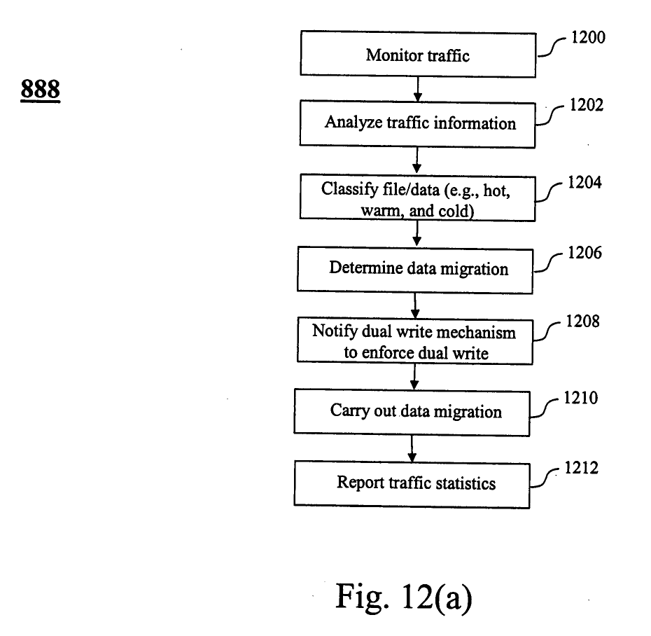

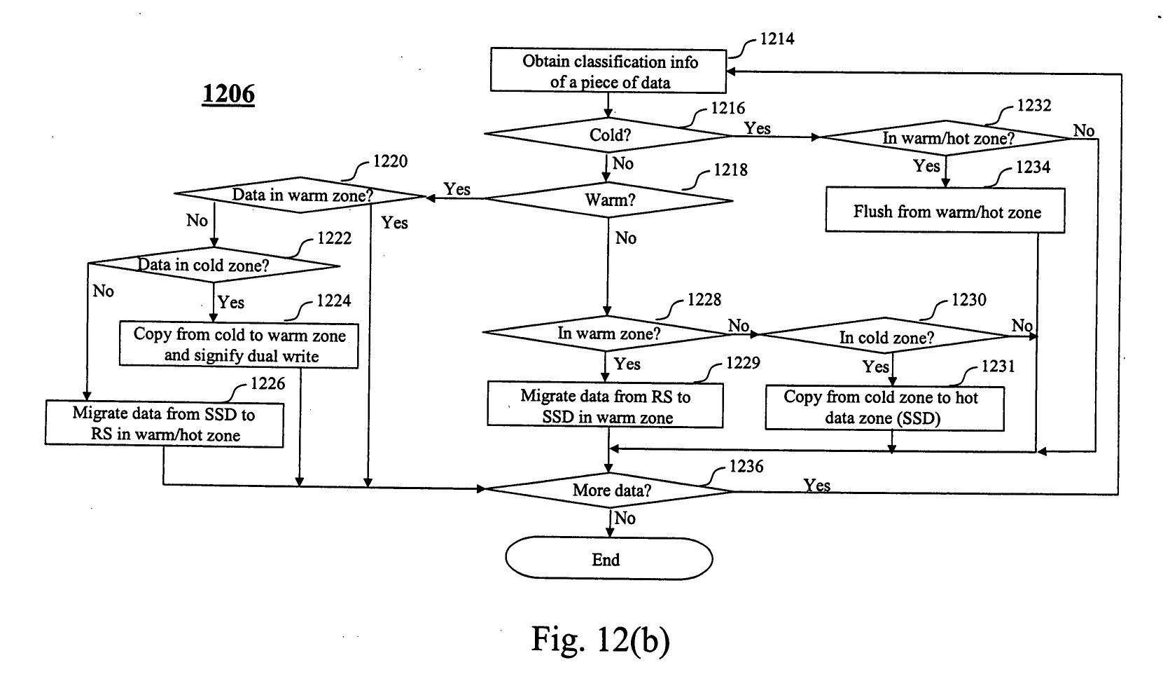

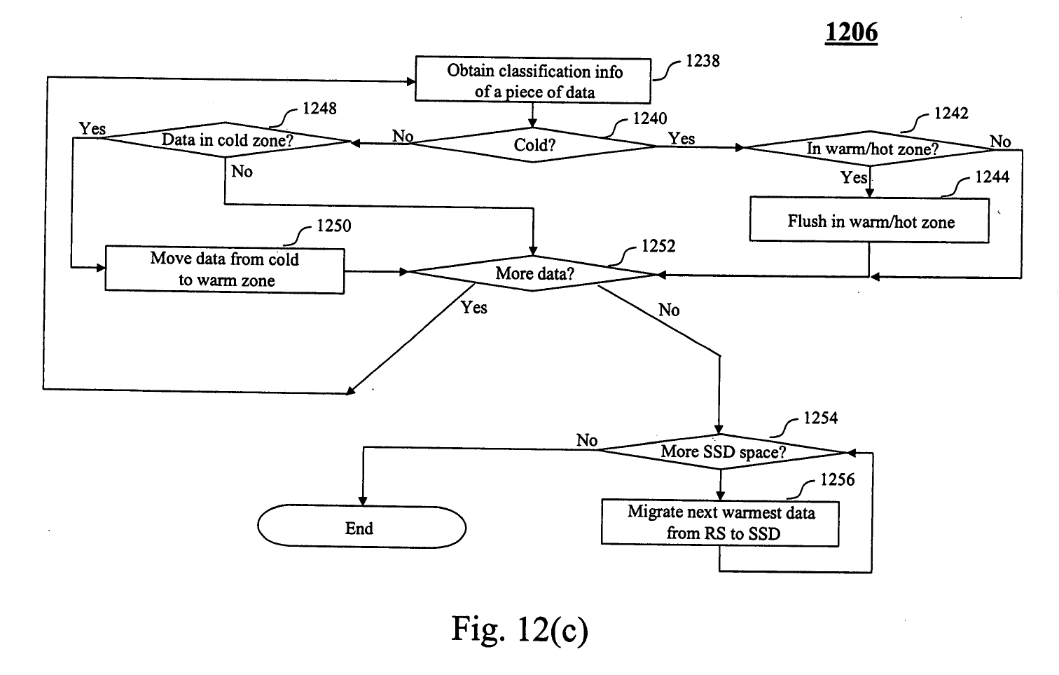

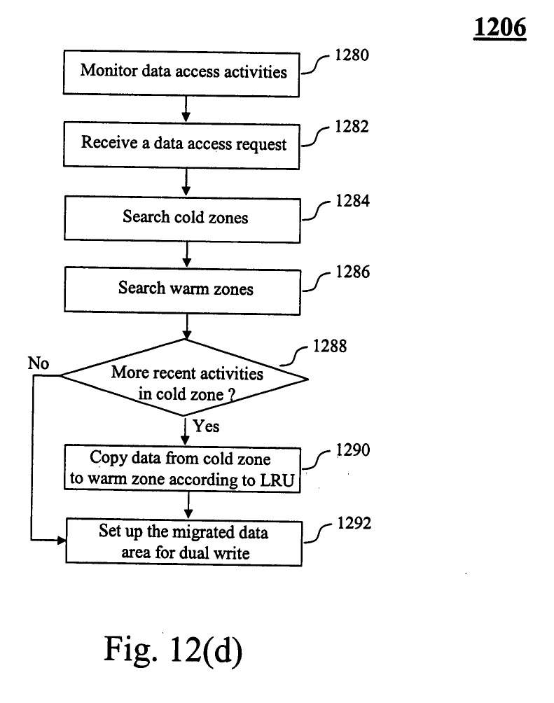

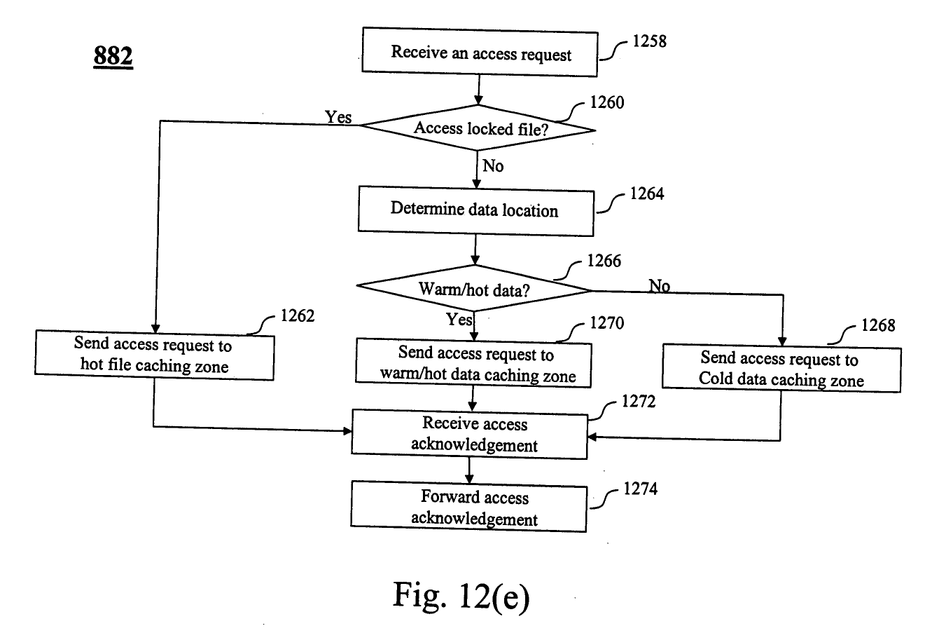

FIG. 8(c) is a flowchart of an exemplary process, in which the storage management system 812 manages the configurable storage space in 800 using a multiple caching scheme, according to an embodiment of the present invention. The storage space is first configured at act 876. When the configurable storage system 800 receives, at act 878, an information access request from the host 110, it is determined, at act 880, whether the request is a read or a write request. A read request is processed at act 882. A write request is processed at act 884. Details related to processing a read/write request are described with reference to FIG. 12(e). After the information access request is processed, the configurable storage system sends, at act 886, a reply to the host that issues the request.

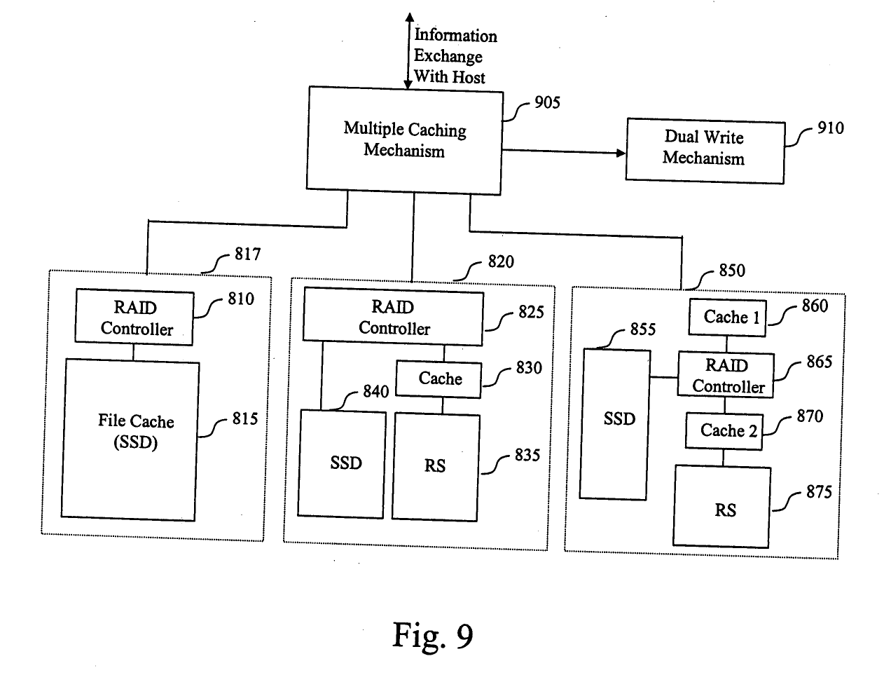

Multiple caching may be performed after each information access processing or it may also be performed according to a regular schedule. Alternatively, it may also be performed according to some pre-determined condition. For example, multiple caching may be performed when the information movement reaches certain volume. When it is determined, at act 888, that multiple caching administrations are to be performed, the storage management system 812 performs, at act 890, the multiple caching administration. Details related to a multiple caching mechanism are described below with reference to FIGS. 9-11. An exemplary process flow with respect to multiple caching is described below with reference to FIGS. 12(a)-12(c).

According to the described multiple caching scheme, data or files may be written along the hierarchy, depending on their dynamic accessing patterns. The storage management system 812 monitors the dynamics of information accesses and determines how data should be migrated within the configurable storage system to optimize the performance. FIG. 9 depicts how a multiple caching mechanism 905 in the storage management system 812 interacts with the three caching zones to achieve dynamic multiple caching, according to an embodiment of the present invention.

The multiple caching mechanism 905 monitors the information traffic occurring in different caching zones. Based on the information traffic patterns, the multiple caching mechanism 905 classifies the underlying data into a category of cold, warm, or hot. According to the classification and current location of the underlying data, the multiple caching mechanism 905 determines necessary data migration and performs such migration. Information related to migration and locations of data is sent to a dual write mechanism 910 that makes sure that data stored in both cold and warm/hot zones are updated at the same time.

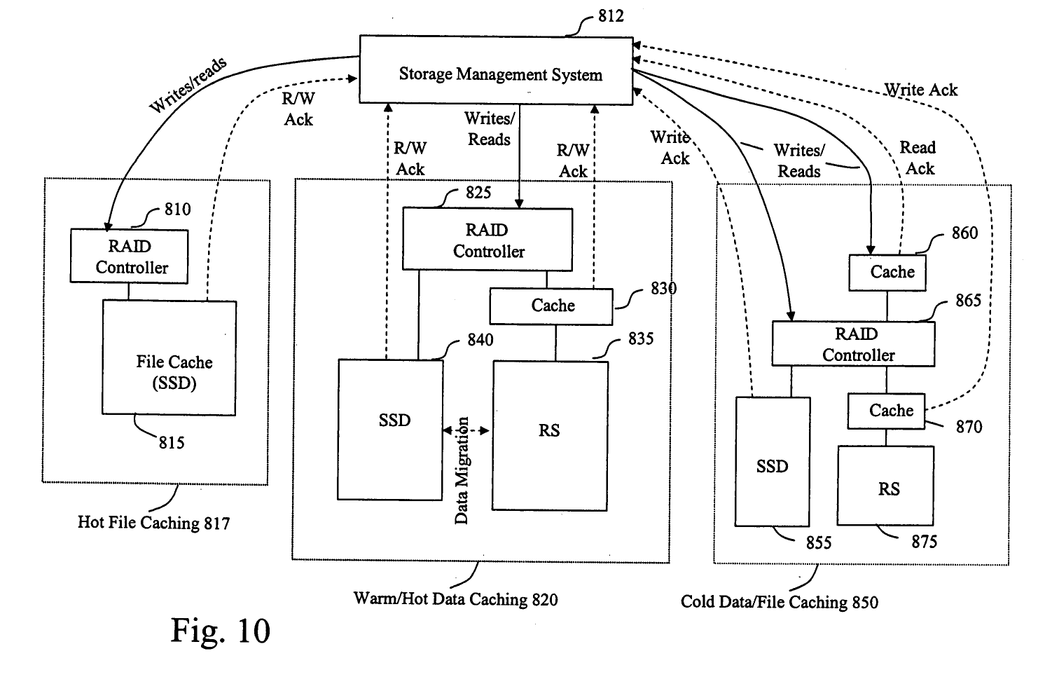

FIG. 10 illustrates an exemplary data access acknowledgement scheme, according to an embodiment of the present invention. All information access requests, including read requests and write requests, are sent from the storage management system 812 to appropriate storage components. For instance, if a request involves reading or writing a locked file, the request is sent to the hot file caching zone 817. If a request involves writing a piece of data that is in the warm/hot data caching zone 820, the write request is sent to both the cold data caching zone 850 and the warm/hot data caching zone 820, individually. After the storage management system sends the data access request, it waits until either an acknowledgment or an error is received from where the request is directed.

In FIG. 10, solid lines represent information requests sent to different caching zones and dotted lines represent acknowledgements sent from different caching zones to the storage management system 812. As shown in FIG. 10, a read request directed to the cold data/file caching zone 850 is handled by the cache 860. Upon the completion of the read operation, the cache 860 sends a read acknowledgement to the storage management system 812. A write request directed to the cold data/file caching zone 850 is handled by either the cache 870 or the SSD 855 (if it is used as a write cache). Upon the completion of the write operation, the storage management system 812 receives a write acknowledgement from either of the two, depending on which one is handling the request.

An access request directed to the warm/hot data caching zone 820 may be sent to the RAID controller 825, which may further determine where to direct the request. If the data to be accessed (either read or write) is stored in the rotating storage 835 (the data is warm), the RAID controller 825 forwards the request to the cache 830 (if it is so designated). In this case, the cache 830 acknowledges upon the completion of the requested information access. Otherwise, the request is forwarded to the SSD 840 and an acknowledgement is sent when information access is successful. When a information request involves data stored in both cold and warm zones, the system management system 812 first receives the acknowledgement from the faster zone and acts on the first acknowledgement.

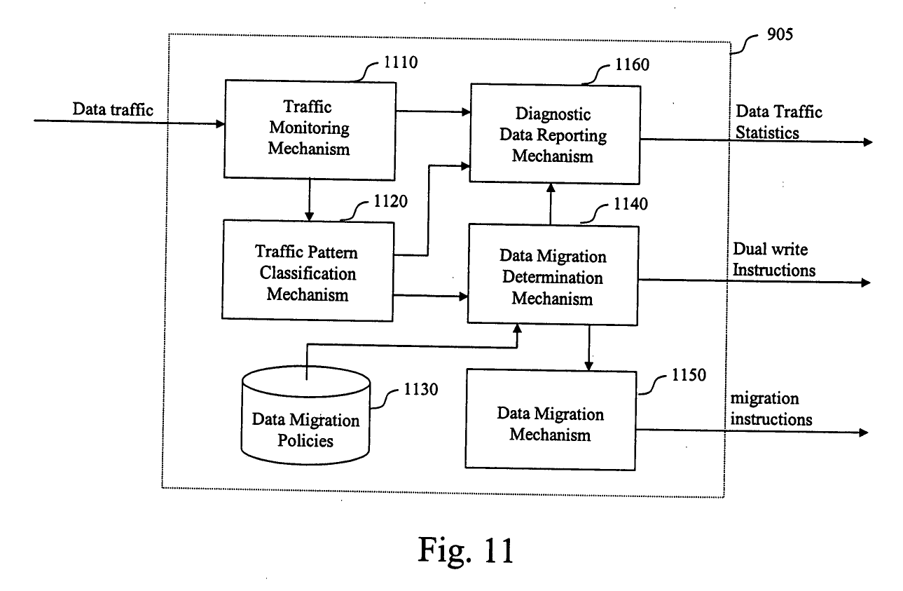

FIG. 11 depicts an exemplary internal structure of the multiple caching mechanism 905, according to an embodiment of the present invention. The multiple caching mechanism 905 comprises a traffic monitoring mechanism 1110, a information access pattern classification mechanism 1120, a plurality of information migration policies 1130, a data migration determination mechanism 1140, a data migration mechanism 1150, and a diagnostic data reporting mechanism 1160. The traffic monitoring mechanism 1110 monitors information traffic and collects information such as which piece of information is accessed when and from which zone.

According to monitored information traffic information, the information access pattern classification mechanism 1120 may summarize the information in order to classify the information access pattern associated with each piece of data. For example, the information pattern classification mechanism 1120 may derive information access frequency information, such as number of accesses per second, from the monitored traffic information. The categories used to classify access pattern include cold, warm, and hot. Alternatively, it may include just cold and warm categories.

The classification may be based on some statistics derived from the traffic information such as the frequency measure (e.g., more frequently accessed data is hotter). The criteria used in such classification (e.g., what frequency constitutes hot) may be predetermined as a static condition or may be dynamically determined according to the configuration (e.g., capacity) of the storage system. If it is predetermined, such criteria may be stored in the multiple caching mechanism 905 (not shown) or hard coded.

Dynamic criteria used to reach different classifications may be determined on the fly based on dynamic information such as the amount of available space in a particular zone at a particular time. For example, a criterion used in classifying a file as a hot file may be determined according to the storage space currently available for hot file caching with respect to, for example, the total amount of information currently stored. Similarly, how frequent the data access has to be for a piece of data to become hot may be determined according to how much space is currently available in the solid state disks 840 in the warm/hot data caching zone 820. The more space there is in the solid state disks 840, the lower the required frequency used to classify a piece of data as being hot. The classification may be performed with respect to all the data or files that are involved in data movement in a recent period of time. This period of time may be defined differently according to needs. For example, it may be defined as during the last 5 minutes.

According to the classification with respect to data/files, the data migration determination mechanism 1140 determines which pieces of data may need to be migrated. As described earlier, a piece of data may migrate along the multiple caching hierarchy from the cold zone to either the warm or the hot zone, from the warm zone to the hot zone, from the warm zone to the cold zone, or from the hot zone to the cold zone. A migration decision regarding a piece of data may be made based on both the current zone at which the data is currently stored and the current classification of the data. If the current storage zone does not match with the current classification and if there is space for a migration, the data migration determination mechanism 1140 may possibly make a decision to migrate the data to optimize the performance.

A plurality of data migration policies 1130 may be used by the multiple caching mechanism 905 in reaching data migration decisions. For instance, such policies may define what conditions a data migration decision should be made based on or criteria used in determining migration decisions on different types of data. Such policies may be stored in the multiple caching mechanism 905 and invoked when needed.

Data migration decisions are made dynamically and they may affect how the multiple storage zones are maintained. Therefore, once a data migration decision is made, the data migration determination mechanism 1140 may send relevant information to the dual write mechanism 910. For instance, if a piece of data is determined to be moved from the cold zone to the warm zone, dual write needs to be enforced in all future writes. In this case, the data migration determination mechanism 1140 sends dual write instructions to the dual write mechanism 910.

The data migration mechanism 1150 takes the data migration decisions as input from the data migration mechanism 1140 and implements the migration. It may issue information movement (migration) instructions to relevant storages in associated zones and make sure that the migration is carried out successfully. In case of error, it may also determine that the record of which piece of information is where in the multiple caching mechanism 905 is consistent with the physical distribution of the information.

As mentioned above, data migration decisions may be made according to different types of underlying information. For instance, when a file is involved, the data migration determination mechanism 1140 may not be able to make a decision to physically move or copy the file in question to a different storage location. Such a decision may be designated to a human operator such as a DBA. Also as mentioned above, such limits may be stored as data migration policies (1130) and complied with by the data migration determination mechanism 1140. Such policies may also define the appropriate actions to be taken when the data migration determination mechanism 1140 encounters the situation. For instance, a policy regarding a file may state that when a cold file becomes hot, the situation should be alerted. In this case, the data migration determination mechanism 1140 may activate the diagnostic data reporting mechanism 1160 to react.

The diagnostic data reporting mechanism 1160 may be designed to regularly report data traffic related statistics based on information from the traffic monitoring mechanism 1110 and the traffic pattern classification mechanism 1120. It may also be invoked to generate diagnostic data to alert administrators when information traffic presents some potentially alarming trend.

FIG. 12(a) is a flowchart of an exemplary process, in which the multiple caching mechanism 905 realizes a multiple caching scheme based on traffic dynamics, according to an embodiment of the present invention. Information traffic is monitored at act 1200. Such monitored traffic information is analyzed at act 1202. Based on the analysis, various measures or statistics regarding traffic pattern may be derived and used to classify, at act 1204, information into different categories (e.g., warm and cold). Using the classifications and the information related to the current storage location of the data, data migrations are determined at act 1206. Details related to how to determine data migration among different zones are discussed with reference to FIGS. 12(b) and 12(c). The dual write mechanism 910 is notified, at act 1208, of relevant migrations of different pieces of data for which dual write needs to be enforced in the future due to the migration decision to switch the data from the cold zone to either the warm or hot zone.

When a piece of data is determined to switch from the cold zone 850 to the warm/hot data caching zone 820, there may be different alternatives to implement data migration. In one embodiment, the data may be copied to the warm/hot zone, at act 1210, as soon as the zone change is determined. In a different embodiment, the data may not be necessarily copied to the warm/hot zone. Instead, the intended migration may be recorded so that when the data is next written, a dual write will be carried out to ensure that the data is written to the warm/hot zone. The multiple caching mechanism 905 also reports, at act 1212, information traffic statistics either on a regular basis or on a alert basis.

FIG. 12(b) is a flowchart of an exemplary process, in which the multiple caching mechanism 905 makes a data migration determination according to traffic pattern classification, according to an embodiment of the present invention. The traffic pattern classification is first obtained at act 1214. The obtained information is examined, at act 1216, to see whether the underlying data is classified as cold. If it is not cold, it is further determined, at act 1218, to see whether it is classified as warm.

If the underlying data is classified as warm and the data is already stored in the warm zone, determined at act 1220, there is no need to migrate the data. If the underlying data is currently stored in cold zone, determined at act 1222, the data is either copied, at act 1224, to the warm zone or recorded as residing in the warm zone (so that when it is updated, it will be written into the warm zone as well). At the same time, the dual write mechanism 910 is notified of the zone change of the underlying data. If the data is not in cold and warm zones, it is migrated, at act 1226, from the hot data zone (the SSD 840) to the warm data zone (the rotating storage 835).

If the underlying data is classified as hot and it is currently stored in the warm zone (the rotating storage 835), determined at act 1228, the data is migrated, at act 1229, from the warm zone (the rotating storage 835) to the hot zone (SSD 840). If the underlying data is currently stored in the cold zone, determined at act 1230, it is either copied, at act 1231, from the cold zone 875 to the hot zone (SSD 840) or recorded as residing in the hot zone so that it will be written in the hot zone when next update occurs. If the data is already stored in the hot zone 840, there is no need to migrate.

If the underlying data is classified as cold and currently has a copy stored in warm/hot zone 820, determined at acts 1216 and 1232, the copy of the data stored in the warm or hot zone is flushed at act 1234. Since each piece of data in either the warm or the hot zone has an up-to-date copy in the cold zone, there is no need to move the data back to the cold zone when it becomes cold again. The flushing operation described above may not refer to a physical flush operation. It may correspond to a simple operation to mark the storage space occupied by the underlying data as available. The above described process of determining data migrations continue until, determined at act 1236, all pieces of active data have been processed.

FIG. 12(c) is a flowchart of an exemplary process, in which the multiple caching mechanism 905 makes a data migration determination according to traffic pattern classification, according to a different embodiment of the present invention. In this embodiment, traffic patterns are classified into only two categories: cold and warm. The data migration decisions are made hierarchically. The data migration determination mechanism 1140 may first determine data migrations between the cold zone 850 and the warm/hot zone 820 and then determine the internal migration within the warm/hot zone 820 according to the availability of the solid state storage 840.

The traffic pattern classification of an underlying piece of data is first obtained at act 1238. The obtained information is examined, at act 1240, to see whether the underlying data is classified as cold. If it is cold, it is further determined, at act 1242, to see whether it currently has a copy stored in the warn/hot zone 820. If the underlying data currently has a copy stored in the warm/hot zone 820, that copy is flushed, at act 1244, from the warm/hot zone 820 (from either the rotating storage 835 or the solid state disks 840). As described above, since there is no need to move the data back to the cold zone, the flush operation may correspond to return of the storage space.

If the underlying data is classified as warm/hot and it is currently stored in the cold zone 850, determined at acts 1240 and 1248, it is either written, at act 1250, from the cold zone 850 to the warm storage 835 or recorded as being migrated to the warm zone 835. The process of migrating data between the cold zone 850 and the warm storage 835 continues until, determined at act 1252, all pieces of data involved in recent information traffic have been processed.

At the second level of the data migration process, part of the data stored in the warm storage 835 may be migrated to the hot storage 840 according to the availability of the hot storage. When there is more space remaining, determined at act 1254, a piece of data that is the warmest is migrated, at act 1256, from the rotating storage 835 to the solid state disks 840.

Other alternative data migration decision schemes may also be employed. FIG. 12(d) is a flowchart of an exemplary process, in which data migration decisions are made based on recent activities monitored in different zones, according to an embodiment of the present invention. Data access activities on different storage zones may be monitored, at 1280, regularly or upon activation. When a regular monitoring schedule is in force, the interval of the monitoring may be specified through some user-defined parameters. Such monitoring may also be activated by administrators. For example, an administrator may activate the data migration when such needs arise. Once activated, the monitoring of data access activities may be performed on a regular basis (e.g., certain interval) or on a continuous basis until it is deactivated.

When data access activities are monitored, different data access activities in various storage zones may be observed. Such observation may also be recorded and used to determine when a piece of data is to be migrated when it is to be accessed. For instance, when a data access request is received, at 1282, both cold zones and warm zones may be searched, at 1284 and 1286, to determine the data access activities with respect to the piece of data. Such search of different zones may be performed sequentially. For example, the cold zones may be searched prior to warm zones. The search in different zones may also be performed in parallel.

To facilitate future faster access, it may be determined whether the piece of data is to be migrated. Such data migration decisions may be made according to the monitored data access activities with respect to different storage zones. Data access activities in different zones may be compared to determine which zone has more recent activities. For instance, if the cold zone has more recent data access activities, determined at 1288, the piece of data in the cold zone may be migrated or copied, at 1290, to a certain location in a warm zone. The location where the data from the cold zone is migrated to may be determined according to some pre-specified criteria. For example, it may be determined according to the least recently used (LRU) principle. It may also be determined according to other alternative criteria such as time stamps. When the data access is complete, the location of the warm zone where the piece of data is migrated to may be set, at 1292, for future dual write operation.

FIG. 12(e) is a flowchart of an exemplary process, in which the storage management mechanism 812 handles an access request (either read or write), according to an embodiment of the present invention. An access request is first received, at act 1258, from a host (or a server). The request is analyzed to determine, at act 1260, whether it is associated with a locked file stored in the hot file caching zone 817. If it is a request to access a locked file, the storage management system 812 sends, at act 1262, an access request to the hot file caching zone 817. Upon receiving, at act 1272, an acknowledgement (or error message) from the hot file caching zone 817, the storage management system 812 forwards, at act 1274, the acknowledgement (or error) to the host.

If the access request is associated with a piece of data, the storage location where the requested data is stored is determined at act 1264. For example, the data may be stored in the warm/hot data caching zone 820 or the cold data zone 850. If the data is stored in the cold caching zone 850, the storage management system 812 sends, at act 1268, an access request to the cold caching zone 850. If the data is stored in the warm/hot data caching zone 820, determined at act 1266, the storage management system 812 sends, at act 1270, an access request to the RAID controller 825. When the storage management system 812 receives, at act 1272, an access acknowledgement (error) from where the read request is directed, it forwards, at act 1274, the access acknowledgement (error) to the host.

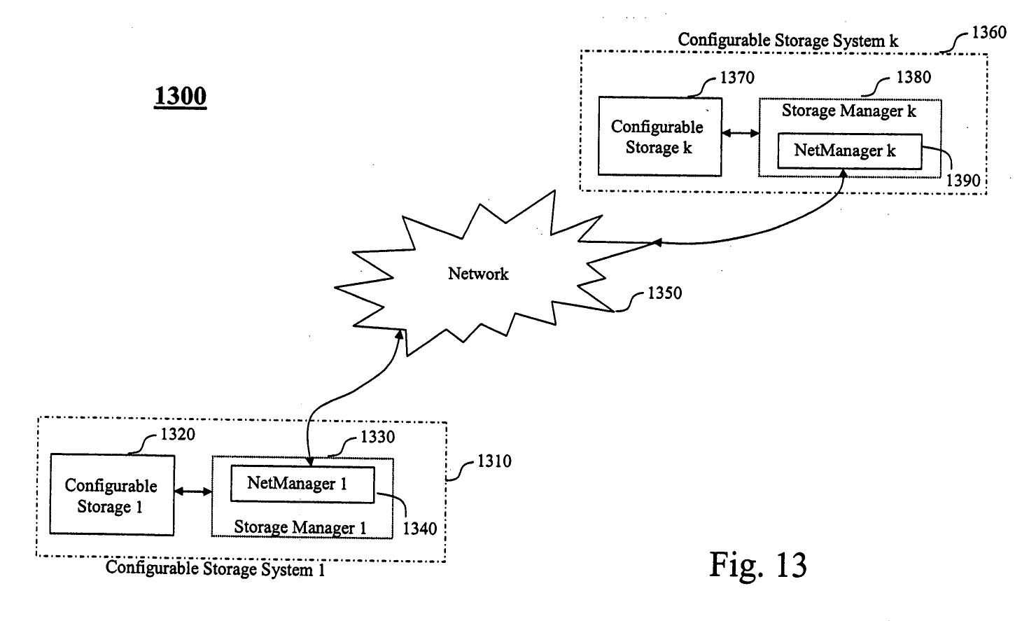

FIG. 13 depicts a distributed storage system 1300, according to an embodiment of the present invention. The distributed storage system 1300 comprises a plurality of configurable storage systems (1310, . . . , and 1360) across a network 1350. Each of the configurable storage systems includes a storage (1320, . . . , and 1370) that is configurable using various storage components described above or any combination thereof. Each configurable storage system may be managed by a local storage manager (1330, . . . , 1380) that includes a network manager (NetMANAGER 1340, . . . , 1390) that facilitates the cooperation and synchronization with remote configurable storage systems. Such cooperation and synchronization may be necessary when a portion of information in one storage system is backed up at a remote site so that information integrity needs to be ensured across the network 1350. The distributed storage system 1300 is highly configurable due to the fact that each local storage system can be flexibly configured based on needs.

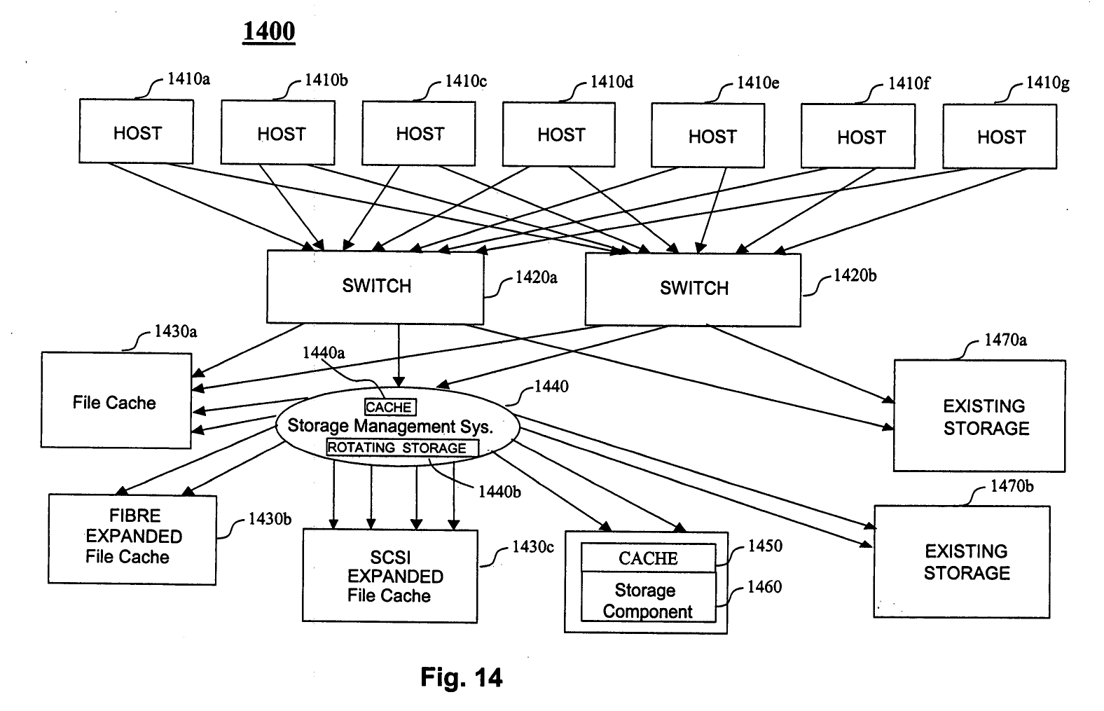

FIG. 14 depicts a framework 1400 in which the described configurable storage system (710 or 800) serves as a managed storage for a plurality of hosts. The storage management system 1440 serves the storage needs of multiple hosts (1410a, 1410b, . . . , 1410g). It connects to the hosts via one or more network switches (1420a, . . . , 1420b).

The storage management system 1440 manages a plurality of storage computers, including, but is not limited to, some internal storage space such as a rotating storage 1440b and its corresponding cache 1440a, a file cache 1430a, a Fibre expanded file cache 1430b, an SCSI expanded file cache 1430c, one or more storage components (e.g., 130, 320, 410) 1460 with their own cache 1450, and other existing storage (1470a, . . . , 1470b). The storage management system 1440 may link to each of the storage components via more than one connections.

The file cache storage (1430) use solid state disks. Some of the file cache storage may be fibre enabled and some may be SCSI enabled. Depending on the needs, any of the file cache storage (1430a, . . . , 1430c) can be configured to serve different needs. For example, they may be used to store locked files. They may also serve as external cache for the hosts. Such cache space may be shared among the hosts and managed by the storage management system 1440.

The storage management system 1440 interfaces with the hosts, receiving requests and performing requested information access operations. Based on the information traffic pattern, it dynamically optimizes storage usage and performance by storing information at locations that are most suitable to meet the demand with efficiency.

While the invention has been described with reference to the certain illustrated embodiments, the words that have been used herein are words of description, rather than words of limitation. Changes may be made, within the purview of the appended claims, without departing from the scope and spirit of the invention in its aspects. Although the invention has been described herein with reference to particular structures, acts, and materials, the invention is not to be limited to the particulars disclosed, but rather can be embodied in a wide variety of forms, some of which may be quite different from those of the disclosed embodiments, and extends to all equivalent structures, acts, and, materials, such as are within the scope of the appended claims.

What is claimed is:

1. A storage system, comprising:
at least one storage component capable of receiving an information access request, processing the information access request, and sending a reply to indicate a status related to the processing, the at least one storage component having a plurality of independently programmable solid state disks.

2. The system according to claim 1, wherein each of the solid state disk can be programmed as one of:
a cache to a rotating storage; and
a storage space.

3. The system according to claim 1, wherein the information requested by the information access request is directed to one of the solid state disks and the solid state disk to which the information access request is directed generates an acknowledgement.

4. The apparatus according to claim 1, wherein each of the solid state disks has a battery and a backup space.

5. A storage apparatus, comprising:
at least one RAID controller;
a rotating storage controlled by the at least one RAID controller, providing storage space; and
at least one solid state disk controlled by the at least one RAID controller.

6. The apparatus according to claim 5, wherein each solid state disk is independently programmable as one of:
a cache to the rotating storage; and
a storage space.

7. A storage apparatus according to claim 5, further comprising:
a cache controlled by the at least one RAID controller providing cache to the rotating storage; and
a system control mechanism capable of interfacing with a host residing outside of the apparatus and controlling information movements within the storage apparatus.

8. The apparatus according to claim 7, wherein the cache and the at least one solid state disk can be programmed as one configuration of:
the cache being a primary cache and the at least one of the solid state disk being a secondary cache of the rotating storage;
the at least solid state disk being the primary cache and the cache being the secondary cache of the rotating storage;
the cache as the cache of the rotating storage and the at least one solid state disk as additional storage to the rotating storage.

9. A storage apparatus according to claim 5, wherein:
the at least one RAID controller, the rotating storage and the at least one solid state disk form a first storage compartment, the storage apparatus further comprising:
at least one host capable of issuing an information access request and receiving a reply transmitted to the host issuing the information access request as a response to the information access request;
the first storage component capable of receiving the information access request via one or more connections with the host, processing the information access request, and sending the reply to the host to indicate a status related to the processing;
a second storage component, having at least one solid state disk where each of the at least one solid state disk is programmable, capable of providing access to information stored therein; and
a storage management system capable of managing a configurable storage space formed by the at least one storage component and the second storage component, interfacing with the host, directing a storage component in the configurable storage space to process the information access request, and sending the reply to the host issuing the information access request, wherein the storage management system is further capable of managing the configurable storage space according to a multiple caching scheme, in which the configurable storage space is functionally divided into a plurality of zones and each of the zones stores information having a corresponding traffic pattern.

10. The system according to claim 9, wherein the plurality of zones include at least one of:
a hot file caching zone capable of storing files that are frequently accessed;
a cold file and data caching zone capable of storing files and data that are infrequently accessed;
a warm data caching zone capable of storing data that are neither frequently not infrequently accessed; and
a hot data caching zone capable of storing data that are frequently accessed.

11. The system according to claim 9, wherein the storage management system comprises:
a multiple caching mechanism capable of performing said multiple caching; and
a dual write mechanism capable of causing data to be written in a warm data caching zone to also be written to a cold file and data caching zone.

12. The system according to claim 11, wherein the multiple caching mechanism comprises:
a traffic monitoring mechanism capable of monitoring information traffic between the storage system and the at least one host;
a traffic pattern classification mechanism capable of using monitored information traffic information to derive traffic pattern classifications;
a data migration determination mechanism capable of making data migration determinations to migrate data stored in the configurable storage space among different caching zones based on the traffic pattern classifications; and
a data migration mechanism capable of controlling data migration based on the data migration determinations.

13. The system according to claim 12, further comprising a diagnostic data reporting mechanism capable of reporting statistics generated based on the information traffic and diagnostic information derived based on the traffic pattern classifications.

14. A storage system, comprising:
at least one storage component capable of receiving an information access request, processing the information access request, and sending a reply to indicate a status related to the processing, the at least one storage component having a plurality of independently programmable solid state disks; and
a storage management system capable of managing a configurable storage space formed by the at least one storage component, interfacing with a host outside of the system, directing a storage component in the configurable storage space to process the information access request, and sending the reply to the host issuing the information access request, wherein the storage management system is further capable of managing the configurable storage space according to a multiple caching scheme, in which the configurable storage space is functionally divided into a plurality of zones and each of the zones stores information having a corresponding traffic pattern.

15. The system according to claim 14, wherein the plurality of zones include at least one of:
a hot file caching zone capable of storing files that are frequently accessed;
a cold file and data caching zone capable of storing files and data that are infrequently accessed;
a warm data caching zone capable of storing data that are neither frequently not infrequently accessed; and
a hot data cachign zone capable of storing data that are frequently accessed.

16. The system according to claim 14, wherein the storage management system comprises:
a multiple caching mechanism capable of performing said multiple caching; and
a dual write mechanism capable of causing data to be written in a warm data caching zone to also be written to a cold file and data caching zone.

17. The system according to claim 16, wherein the multiple caching mechanism comprises:
a traffic monitoring mechanism capable of monitoring information traffic between the storage system and the at least one host;
a traffic pattern classification mechanism capable of using monitored information traffic information to derive traffic pattern classifications;
a data migration determination mechanism capable of making data migration determinations to migrate data stored in the configurable storage space among different caching zones based on the traffic pattern classifications; and
a data migration mechanism capable of controlling data migration based on the data migration determinations.

18. The system according to claim 17, further comprising a diagnostic data reporting mechanism capable of reporting statistics generated based on the information traffic and diagnostic information derived based on the traffic pattern classifications.

19. A storage management system capable of managing a configurable storage space according to a multiple caching scheme, in which the configurable storage space is functionally divided into a plurality of zones, each of which stores information having a corresponding traffic pattern.

20. The system according to claim 19, wherein the traffic pattern includes at least some of:
hot indicating frequent information access;
cold indicating infrequent information access; and
warm indicating neither frequent nor infrequent information access.

21. The system according to claim 20, wherein the plurality of zones include at least one of:
a hot file caching zone capable of storing files that are hot;
a cold file and data caching zone capable of storing files and data that are cold;
a warm data caching zone capable of storing data that are warm; and
a hot data zone capable of storing data that are hot.

22. The system according to claim 21, wherein the storage management system comprises:
a multiple caching mechanism capable of performing said multiple caching; and
a dual write mechanism capable of causing data to be written in the warm data caching zone to also be written to the cold file and data caching zone.

23. The system according to claim 22 wherein the multiple caching mechanism comprises:
a traffic monitoring mechanism capable of monitoring information traffic to and from the storage system;
a traffic pattern classification mechanism capable of using monitored information traffic information to derive traffic pattern classifications;
a data migration determination mechanism capable of making data migration determinations to migrate data stored in the configurable storage space among different caching zones based on the traffic pattern classifications; and
a data migration mechanism capable of controlling data migration based on the data migration determinations.

24. The system according to claim 23, further comprising a diagnostic data reporting mechanism capable of reporting statistics generated based on the information traffic and diagnostic information derived based on the traffic pattern classifications.

25. The system according to claim 23, further comprising a network manager capable of communicating with another storage system distributed across a network to ensure information integrity across the network.

26. A method for a storage management system managing a storage space, comprising:
receiving an information access request;
determining whether the information access request is a read request or a write request;
performing read request processing if the information access request is a read request;
performing write request processing if the information access request is a write request; and
receiving a reply from a storage component responding the information access request; and
managing the storage space according to a multiple caching scheme, in which the storage space is divided into a plurality of caching zones based on information traffic patterns resulted from processing one or more information access requests.

27. The method according to claim 26, wherein information stored in the storage system includes:
a file; and
individual pieces of data.

28. The method according to claim 26, wherein the traffic pattern includes at least one of:
hot indicating frequent information access;
cold indicating least access information; and
warm indicating neither frequent nor infrequent information access.

29. The method according to claim 28, wherein the caching zones include a cold file and data caching zone for the information that are cold and at least one other caching zone and further comprising writing data to be stored in the at least one other caching zone to both the at least one other caching zone and the cold caching zone.

30. The method according to claim 29, wherein the at least one other caching zone include at least one of:
a hot file caching zone capable of storing files that are hot;
a warm data caching zone capable of storing data that are warm; and
a hot data zone capable of storing data that are hot.

31. The method according to claim 30, wherein the managing the storage space according to the multiple caching scheme comprises:
monitoring information traffic resulted from information access requests associated with information stored in the storage space;
classifying the information stored in the storage system into a plurality of traffic patterns according to the observed information traffic;
determining whether any data needs to be migrated to caching zones that correspond to its classified traffic pattern; and
carrying out data migration if it is determined that at least some data is to be migrated.

32. The method according to claim 31, wherein the determining of data migration comprises:
writing data from the cold data caching zone to the warm data caching zone, if the data is currently stored in the cold data caching zone and the classified traffic pattern of the data is warm;
migrating data from the hot data caching zone to the warm data caching zone if the data is currently stored in the hot data caching zone and the classified traffic pattern of the data is warm;
writing data from the cold data caching zone to the hot data caching zone if the data is currently stored in the cold data caching zone and the classified traffic pattern of the data is hot;
migrating data from the warm data caching zone to the hot data caching zone if the data is currently stored in the warm data caching zone and the classified traffic pattern of the data is hot;
flushing data from the warm data caching zone if the data is currently stored in both the cold data caching zone and the warm data caching zone and if the classified traffic pattern of the data is cold; and
flushing data from the hot data caching zone if the data is currently stored in both the cold data caching zone and the hot data caching zone and if the classified traffic pattern of the data is cold.

33. The method according to claim 30, wherein the performing of read request processing comprises:
sending the read request to the hot file caching zone, if the read request is for a file stored in the hot file caching zone;
sending the read request to the cold data caching zone, if the piece of data is stored only in the cold data caching zone;
sending the read request to the warm data acaching zone, if a copy of the piece of data is stored in the warm data caching zone; and
sending the read request to the hot data caching zone, if a copy of the piece of data is stored in the hot data caching zone.

34. The method according to claim 32, further comprising generating a read acknowledgement by a caching zone to where the read request is sent.

35. The method according to claim 30, wherein the performing of write request processing comprises:
sending the write request to the hot file caching zone, if the write request is for a file stored in the hot file caching zone;
sending the write request to the cold data caching zone, if the piece of data is stored only in the cold data caching zone;
sending the write request to both the cold data caching zone and the warm data acaching zone, if the piece of data is stored in both the cold data caching zone and the warm data caching zone; and
sending the write request to both the cold data caching zone and the hot data caching zone, if the piece of data is stored in both the cold data caching zone and the hot data caching zone.

36. The method according to claim 34, further comprising generating a write acknowledgement by a caching zone to where the write request is sent.
